(19) United States
(12) Patent Application Publication
(10) Pub. No.: US 2011/0284742 A1
(43) Pub. Date: Nov. 24, 2011

(54) DETECTION OF Kr-85 GAMMA RAYS FOR POSITIVE VERIFICATION OF MASS IN PRESSURIZED BOTTLES

(75) Inventors: DELMAR L. BARKER, Tucson, AZ (US); Richard J. Wright, Tucson, AZ (US)

(73) Assignee: Raytheon Company

(21) Appl. No.: 12/783,352

(22) Filed: May 19, 2010

(51) Int. Cl. G21H 5/02; G01T 1/00

(52) U.S. Cl. 250/303; 250/336.1

(57) ABSTRACT

A Kr-85 tracer gas is mixed with the carrier gas in a pressurized bottle. External detection of the gamma rays that penetrate through the walls of the bottle provides a non-invasive technique for the positive verification of mass inside the bottle over the lifetime of the bottle

### GOVERNMENT RIGHTS

This invention was made with United States Government support under Contract Number HQ0147-09-D-0001 with the Department of Defense. The United States Government has certain rights in this invention.

### BACKGROUND OF THE INVENTION

1. Field of the Invention

This invention relates to the detection of degradation or failure of pressurized-bottles and in particular to the positive verification of mass inside pressurized bottles.

2. Description of the Related Art

Pressurized bottles are used to store coolant as well as actuator gases for long periods of time. Typically, the pressurized bottles are impossible to check for fill between the time they are installed and when called upon to function. If any latent fault or damage has occurred in the intervening years, the bottle can leak, causing the catastrophic failure of the machine depending on it. The bottles are typically single-shot devices and are consumed if opened, and thus cannot be sampled and refilled. Pressurized bottles include Joule-Thompson Cryo coolers for IR focal plane arrays (FPAs), pneumatic actuators for fins and nozzles and gasses for fire suppression systems.

Previous devices have attempted to measure pressure effects on the bottle to determine if it is loaded with high pressure gas. The most common version is to attach a Bourdon tube type pressure gage directly to the bottle. The device can read out the pressure in the bottle directly, though the automated version uses an electrical switch to denote if a bottle has dropped below a reference pressure. The Bourdon gage itself is the source of several potential leak paths in the Bourdon tube as well as the joints needed to attach it. A diaphragm type pressure gage can be installed, which uses a strain gage on the back side of a thin metal diaphragm. This technology is subject to long term creep effects which cause the reading to drift, and like the Bourdon tube, introduces additional potential leak paths. Applying strain gages directly to the bottle wall can directly measure the strain from being loaded to infer pressure. This technique has been attempted and found to produce false leak detections due to reading drift with time. “Ping” testing uses a mechanical impact to ring the bottle. A fast Fourier Transform of the resulting ringing frequencies detected by an accelerometer is used to infer pressure. This technique has been found to be greatly complicated by useful bottle geometries, and highly susceptible to shifts caused by installation constraint. All of these methods must be compensated for the bottle temperature to be able to determine if the actual proper mass of material is in the bottle.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a non-invasive technique for the positive verification of mass in a pressurized bottle over the lifetime of the bottle.

This is accomplished by mixing a Kr-85 tracer gas with the carrier gas in a pressurized bottle. External detection of the gamma rays that penetrate through the walls of the bottle provides positive verification of mass inside the bottle. In addition, external detection of beta rays from Kr-tracer gas outside the bottles provides positive verification of the occurrence of a gas leak from the bottle.

In an embodiment, a pressurized bottle comprises a mixture of a carrier gas and a Kr-85 tracer gas. The mixture is initially pressurized to at least 3,500 PSI. The Kr-85 tracer gas emits gamma rays that penetrate through the bottle.

In another embodiment, a pressurized bottle comprises a mixture of a carrier gas and a Kr-85 tracer gas. A tag provides a calibration date, a calibrated mass and a calibrated Kr-85 gamma count. The tag may, for example, comprise a bar code, an RF tag or an electronic file associated with a bottle identification number.

In another embodiment, a pressurized bottle comprises a mixture of a carrier gas and a Kr-85 tracer gas. A tag provides a calibration date, a calibrated mass and a calibrated Kr-85 gamma count. A gamma detector external to the bottle counts gamma rays emitted by the Kr-85 tracer gas inside the bottle through the bottle. A processor calculates from the gamma count and the half-life properties of Kr-85 a test mass. The processor compares the test mass to the calibrated mass to provide positive verification of mass in the pressurized bottle.

In another embodiment, a method of positive verification of presence of mass in a pressurized bottle comprises providing of a mixture of a carrier gas and a Kr-85 tracer gas in a high-pressure bottle. The bottle is tagged with a calibration date, a calibrated mass and a calibrated Kr-85 gamma count. The bottle is emplaced in-situ in a system to provide, for example, cooling, and actuation or fire suppression of a sub-system. Gamma rays are detected external to the bottle to measure a test gamma count of gamma rays emitted by the Kr-tracer gas inside the bottle through the walls of the bottle. Based on the test gamma count and the half-life properties of Kr-85 a test mass is calculated. The test mass is compared to the calibrated mass to provide positive verification of mass in the pressurized bottle. The test process may be repeated periodically or based on the occurrence of certain events.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a diagram of a pressurize bottle containing a mixture of carrier gas and Kr-85 tracer gas and a system for detecting gamma rays through the walls of the bottle to provide a positive verification of mass inside the bottle in accordance with the present invention;

FIG. 2 is a flow diagram of an embodiment for providing a pressurized bottle with a Kr-85 tracer gas, emplacing the bottle in-situ to perform a function and periodically measuring the gamma rays to provide positive mass verification over the operational lifetime of the bottle;

FIGS. 3a and 3b are diagrams of an embodiment of a gamma detection system for a bottle that serves to cool a focal plane array detector for a kill-vehicle;

FIG. 4 is a notional diagram of an embodiment of a gamma detection system for a bottle that serves to drive a linear actuator;

FIG. 5 is a diagram of an embodiment of a gamma detection system for a hybrid hydraulic vehicle;

FIG. 6 is a diagram of a pressurize bottle containing a mixture of carrier gas and Kr-85 tracer gas and a system for detecting gamma rays through the walls of the bottle to provide a positive verification of mass inside the bottle and for detecting beta rays of Kr-85 in tracer gas that leaks out of the bottle; and

FIG. 7 is a diagram of a detection system in which each bottle is provided with a gamma detector for positive verification of mass inside each bottle and a shared beta detector for detecting leaks.

### DETAILED DESCRIPTION OF THE INVENTION

The present invention provides a non-invasive technique for the positive verification of mass in a pressurized bottle over the lifetime of the bottle. This is accomplished by mixing a Kr-85 tracer gas with the carrier gas in a pressurized bottle. External detection of the gamma rays that penetrate through the walls of the bottle provides positive verification of mass inside the bottle. In additional, external detection of beta rays provides positive verification of a gas leak from the bottle.

Known techniques such as the Bourdon pressure gage, strain gages or the “ping” test do not provide positive verification of mass in the pressurized lifetime. They rely on evidence on which to draw negative inferences of presence of mass. The reliability and accuracy of such negative inferences is suspect, particularly in very high-pressure bottles (e.g.>3,500 PSI) over long life times, e.g. several years to decades.

A non-invasive technique for the positive verification of mass is useful for all types of pressurized bottles and environments. However, such a technique may find particular import in demanding environments. These environments may require very high pressures, in excess of 3,500 PSI. They may require this pressure level to be maintained for 10 or more years prior to use of the pressurized gas. Proper operation of the bottle may be critical to successful execution of the mission. The bottle may be located “in-situ” where access to the bottle by a technician is very difficult. The environment may demand an accurate measurement over the lifetime. If the technique cannot provide this accuracy, the bottle may have to be over designed, expending valuable resources on volume, weight and cost for a given system. The environment may demand or at least prefer that the technique is non-invasive as invasiveness may compromise both the test results and the integrity of the bottle.

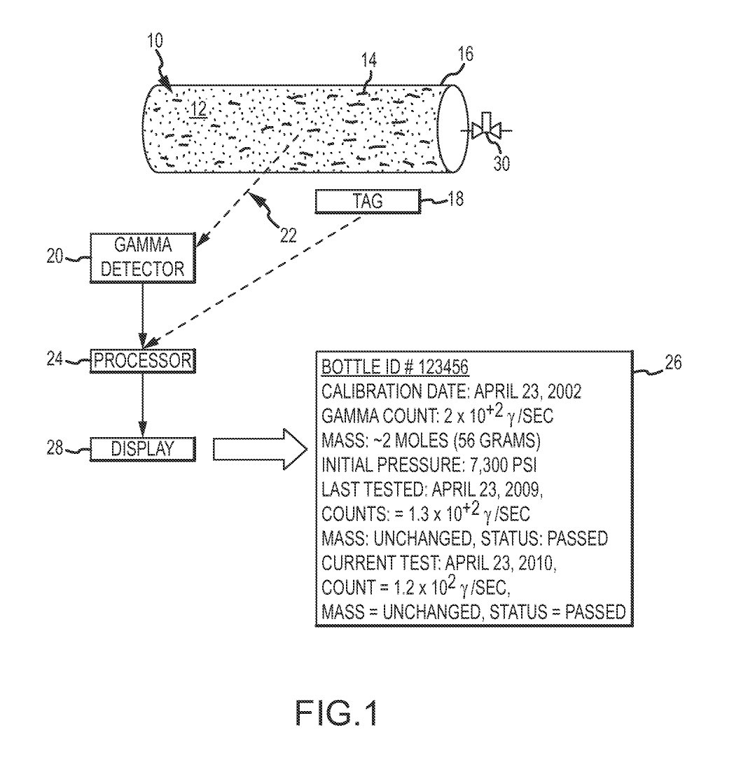

Referring now to FIG. 1, an embodiment of a system for positive verification of mass inside pressurized bottles comprises a mixture 10 of a carrier gas 12 and a Kr-85 tracer gas 14 in a pressurized bottle 16. A tag 18 may provide a calibration date, a calibrated mass inside the bottle and a calibrated Kr-85 gamma count for that mass. The mass may be expressed, for example, as a number of moles or as an actual mass in grams. A gamma detector 20 external to the bottle counts gamma rays 22 emitted by the Kr-85 tracer gas inside the bottle that penetrate through the bottle to the detector. Radioactive isotopes such as Kr-85 emit gamma rays (or photons). A processor 24 calculates from the gamma count and the half-life properties of Kr-85 (based on the calibration data provided by the tag) a test mass.

The processor compares the test mass to the calibrated mass to provide positive verification of mass in the pressurized bottle. The positive verification of mass may then be provided in a report 26 via, for example, a display 28.

Krypton is a colorless, odorless, tasteless gas about three times heavier than air. As a noble gas, krypton is generally inert and forms very view chemical compounds. It occurs in nature as six stable isotopes of which Krypton-84 is the most prevalent. Eleven major radioactive isotopes of krypton exist of which only two—Kr-81 and Kr-85 have appreciable half-lifes. Kr-81 has a half-life of about 210,000 years and Kr-85 has a half-life of 10.76 years. Kr-85 is produced by the fissioning of uranium and plutonium and is present in spent nuclear fuel. Kr-85 is also present in the atmosphere due to neutron capture reactions from cosmic ray neutrons interaction with stable krypton isotopes.

Mixture 10 may have an initial calibrated pressure of a several hundred to a few thousand PSI or greater than 3,500 PSI depending upon the intended application. Typical carrier gases 12 include Nitrogen (N), Argon (Ar), Krypton-84 (Kr-84 that is not radioactive) and Helium (He). The tracer gas 14 is the radioactive isotope Kr-85, which has a half-life of approximately 10.76 years. Other radioactive isotopes do exist but they are not well suited for providing positive verification of mass over the expected life times of pressurized bottles. The half-life of some isotopes is simply too short to provide monitoring over typical periods. The half-life of other isotopes is simply too long to provide a gamma count in a reasonable period of time with an acceptable signal-to-noise ratio. The amount of Kr-85 tracer gas (specified in mole percent) in the mixture will depend on several factors including anticipated background radiation levels, period to measure the gamma rays, safety issues and volume of the bottle In particular, if the percentage of tracer gas is too high the mixture may freeze up when the gas is expelled from the bottle during its intended use. For example, in an embodiment of pressurized bottle configured for cooling a FPA the concentration of Kr-85 tracer gas in a Nitrogen carrier gas is less than 1 mole percent. This threshold may vary with the type of carrier gas and the configuration of the pressurized bottle to perform its intended function e.g. coolant, actuation or fire suppression.

The mixture inside the bottle is governed by the gas law pV=nRT where p is pressure, V is volume, n is the amount of substance in moles, R is the gas constant (8.314471J/K*mo) and T is the temperature in degrees Kelvin. The mass is equal to the number of moles (n) times the molar mass M. In the mixture, the number of moles (n) is apportioned between the number of moles of the carrier gas n_{c} and the number of moles of the tracer gas n_{Kr-85}, which have different molar mass.

Pressurized bottle 16 is typically made of steel with walls between approximately 1/10″ and ¾″ depending on the volume of the bottle and the pressure of the gas mixture. Other materials may be used to form the bottle including any metal or composite structures such as carbon with sufficient strength to contain the high pressure. The gamma rays emitted by the Kr-85 isotope from the tracer gas inside the bottle will penetrate through the walls to a distance that can be detected by detector 20. If the volume/pressure dictate walls that are too thick to allow penetration, a “window” may be formed in the bottle and aligned to detector 20. The beta rays emitted by the Kr-85 isotope from the tracer gas inside the bottle will not penetrate through a metal wall of any appreciable thickness. Bottle 16 comprises a valve 30 to both fill the bottle with pressurized gas and to expel the pressurized gas to cool, actuate or suppress fires. The bottle is typically configured to release the pressurized gas in “1-shot”. Alternately, the bottle could be configured to release gas in multiple shots, which would require recalibration after each shot. This valve, and other penetrations of the bottle such as tubes, windows etc. can have exhibit defects that create failure points where the pressurized gas may leak and escape to the external environment or may rupture and cause catastrophic failure. Beta rays emitted by the Kr-85 isotope that has leaked outside the bottle are detectable. The pressurized bottle may be put in the field and emplaced “in-situ” in a system such as a missile, a kill vehicle, etc to provide coolant for a sub-system such as a FPA, actuation of a sub-system such as a wing or fin or fire suppressant.

Tag 18 may take any one of several different forms to provide the calibration data for the mixture in a particular bottle. For example, tag 18 could be a bar code placed on the bottle, an RF (radio frequency) tag, written documentation or a computer file stored elsewhere and associated with an identification number on the bottle. Typically, the tag will uniquely identify the date, mass and gamma count for that particular bottle. However, if a batch of bottles is filled on the same date with the same mass and amount of Kr-85 the tag could provide calibration data for the entire batch. The calibration data may be specified when the bottle is filled initially or perhaps if and when the bottle is recalibrated. For example, if a bottle was placed in storage it may be recalibrated before being incorporated into a system.

The calibrated mass may be provided in one or more ways including measuring the empty and filled bottle, measuring the pressure and temperature and calculating the mass or directly monitoring the mass that is placed into the bottle. The calibrated gamma count is suitably provided by measuring the actual gamma count outside the bottle for the tracer gas inside the filled bottle. Alternately, the calibrated gamma count may be calculated based on a measurement of the amount of Kr-85 tracer gas placed in the bottle.

Gamma detector 20 detects and counts gamma rays 22 that are emitted from the Kr-85 tracer gas inside the bottle and penetrate through the bottle to the detector. The gamma detector is preferably non-invasive with respect to the bottle. Any type of invasiveness can effect the positive verification of mass and may affect the integrity of the bottle. The gamma may be a form of a Geiger counter, also referred to as a Geiger-Muller counter, in which an inert gas-filled tube briefly conducts electricity when a gamma ray makes the gas conductive. The tube amplifies this conduction and outputs a current pulse. Another device for detecting gamma rays is a scintillation counter. Scintillation detectors use crystals that emit light when gamma rays interact with the atoms in the crystals. The intensity of the light produced is proportional to the energy deposited in the crystal by the gamma ray. The detectors are joined to photomultipliers that convert the light into electrons and then amplify the electrical signal provided by those electrons. Common scintillators include thallium-doped sodium iodide (NaI(Tl))—often simplified to sodium iodide (NaI) detectors—and bismuth germanate (BGO). See for example, Kwang Hyun Kim et al. “Signal and noise performance of large-area PIN photodiodes and charge-sensitive preamplifiers for gamma radiography” Nuclear Instruments and Methods in Physics Research A 591 (2008) 63-66.

Gamma detector 20 is positioned near the bottle to detect and count the gamma rays emitted through the bottle. The detector may be fixed in-situ with the monitored subsystem and/or provided as a man-portable unit. The gamma detector counts the gamma rays over a period of time long enough to provide an acceptable SNR. The raw count is suitably calibrated to compensate for any background gamma radiation due to other sources and the efficiency of the detector. Not all gamma rays emitted by the source and pass through the detector will produce a count in the system. The probability that an emitted gamma ray will interact with the detector and produce a count is the efficiency of the detector. The gamma detector may be configured to perform the measurement every N units of time where the unit could be a day, a month or a year for example or may be configured to perform the measurement upon the occurrence (or planned occurrence) of a certain event such as the use of the bottle for its intended purpose.

Processor 24 may include one or more computer processors and any processor memory required to store and process the calibration and measured data to provide positive verification of mass. The calibration data (date, mass, gamma count) is provided to the processor. For example, upon emplacement of the bottle into a system a bar code may be read and the data stored in the processor or an electronic file corresponding to the bottle ID may be downloaded to the processor. Alternately, an RF tag may broadcast the data to the processor. Given the calibration date of the bottle and the half-life properties of Kr-85, the processor can normalize the measured test gamma count to the calibrated date or vice-versa. Knowing the calibrated gamma count and calibrated mass, the processor can compute the test mass currently inside the bottle. The processor compares the test mass to the calibrated mass to provide positive verification of mass inside the bottle.

The processor may then report out the positive verification of mass. The processor may be configured to report out after every test or only if the mass inside the bottle has changed by a threshold amount. The processor may report out a simple status such as “Passed” or “Failed” or a more complete report 26 as shown in FIG. 1. The report may include a bottle identification number, the initial calibration data and the history of test results for the bottle. In this example, a 40% detector efficiency is assumed without any leaking over time. The status or report could be shown on a display such as display 28. The display could be located in-situ with the bottle in some environments, at a different more accessible location in the system, at a remote monitoring station or on a hand-held device.

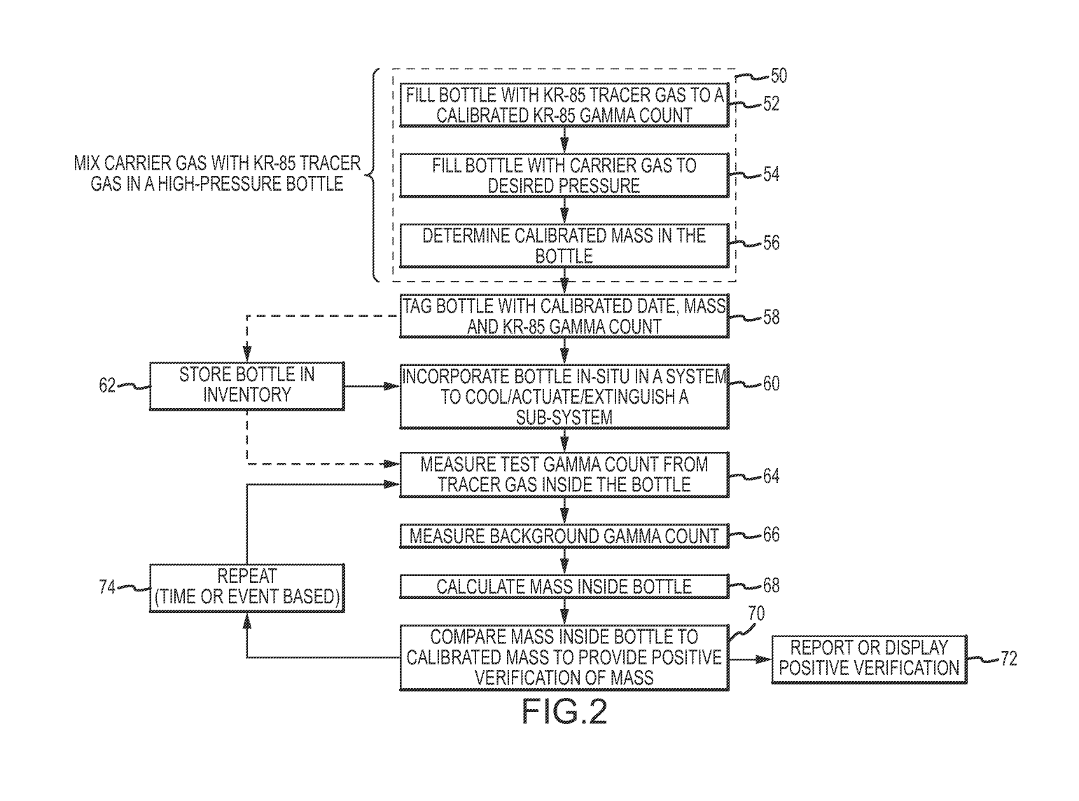

FIG. 2 is a flow diagram of an embodiment for providing a pressurized bottle with a Kr-85 tracer gas, emplacing the bottle in-situ to perform a function and periodically measuring the gamma rays to provide positive mass verification over the operational lifetime of the bottle. A bottle is filled with a mixture of carrier gas and Kr-85 tracer gas under pressure (step 50). In one embodiment, this is accomplished by first filling the bottle with Kr-85 tracer gas to a calibrated Kr-85 gamma count (step 52), filling the bottle with the carrier gas to a desired pressure (step 54) and determining the calibrated mass in the bottle (step 56). The bottle is “tagged” with the calibration date, mass and Kr-85 gamma count (step 58). The bottle is incorporated in-situ in a system to cool/actuate/extinguish a sub-system (step 60) or possibly placed in inventory (step 62). The gamma detector measures a test gamma count from tracer gas inside the bottle (step 64) and suitably measures a background gamma count (step 66) from other sources. The processor uses the calibration data to calculate the mass present inside the bottle (step 68) and compares that mass to the calibrated mass to provide positive verification of mass (step 70). The process reports and/or displays the positive verification (step 72). The gamma detector and processor repeat the monitoring process (step 74). The process may be repeated every hour, day, week, month, year etc. or may be repeated upon the occurrence or before the planned occurrence of an event, e.g. the use of the bottle.

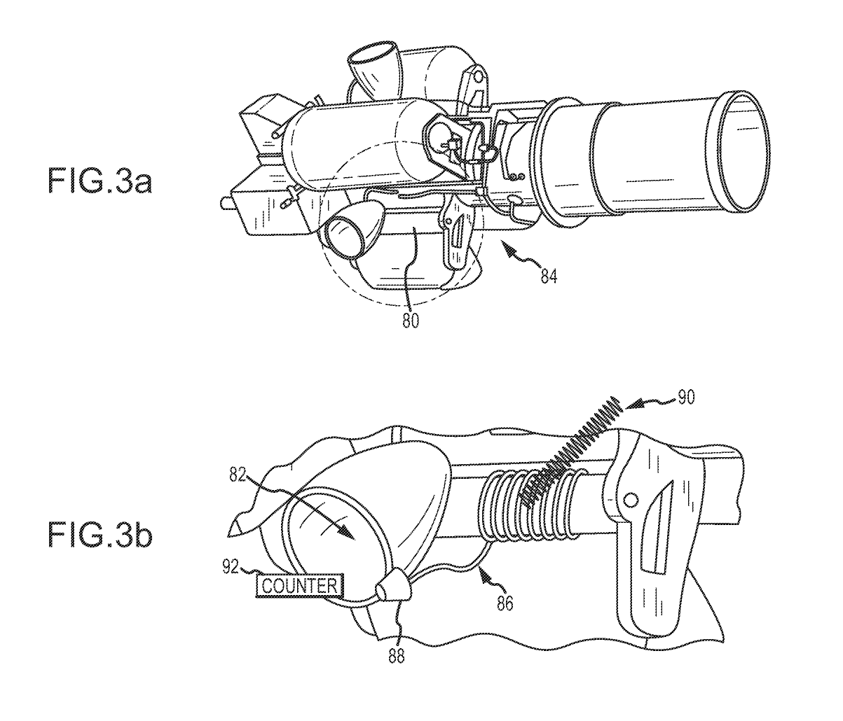

FIGS. 3a and 3b illustrate a pressurized bottle 80 including a mixture of Nitrogen gas and Kr-85 tracer gas emplaced in situ with a gamma detector 82 to cool a focal plane array (FPA) on a kill-vehicle 84. To achieve the SNRs needed for terminal guidance of the kill-vehicle to a target, the FPA must be cooled. At the appropriate time, the valve on the bottle is opened and the high-pressure gas expands through a nozzle becoming cold as it is sprayed onto the FPA. The pressurized bottle is a critical failure point. One or more kill-vehicles are carried as, for example, the third stage of a ballistic missile to launch them into space to intercept enemy missiles. The ballistic missile may be stored underground or in a submarine. Access to the kill-vehicle and pressurized bottle is quite limited. The Kr-85 tracer gas provides a non-invasive capability to provide positive verification of mass in the bottle while in-situ.

In an embodiment, gamma detector 84 may comprise a scintillating optical fiber 86 wrapped around pressurized bottle 80 and a photo detector 88 that is optically coupled to the end of the fiber. When a gamma ray 90 interacts with a properly doped fiber, a light pulse is generated and transported down the fiber to the photo detector. The photo detector converts the optical pulse into an electrical pulse that is registered by a counter 92. The processor may be located in-situ or remotely. The detector is coupled to a communication link of the kill-vehicle/ballistic missile to report out either the raw count if the processor is remote or the processed results of the positive verification.

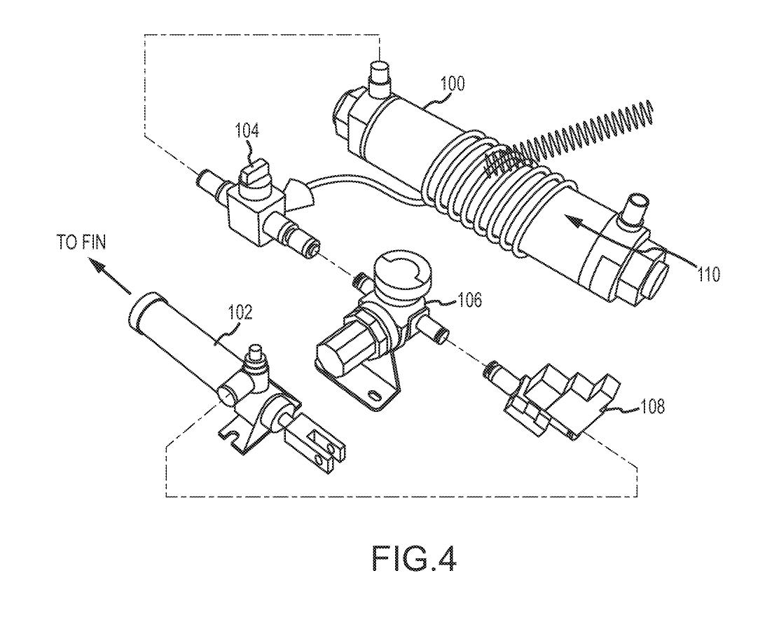

FIG. 4 illustrates a reservoir 100 (a high-pressure bottle) containing a mixture of Helium gas and Kr-85 tracer gas to drive a linear actuator 102 to deploy a fin on a missile. A shut off valve 104 is opened to allow high-pressure gas to flow from reservoir 100 to a regulator 106 and a downstream solenoid driven valve 108. On a command from the guidance system, the solenoid would open the secondary valve 108 and push gas to the linear actuator 102. The actuator would push a stowed fin out of its slot on the missile, extend it, and lock it in the flight position. The Kr-85 tracer gas and gamma detector 110 are used to determine if the reservoir had enough gas to extend the fin. The test could be performed immediately before launch, shortly before the missile was loaded on a carrier aircraft, or perhaps on a regularly scheduled maintenance cycle.

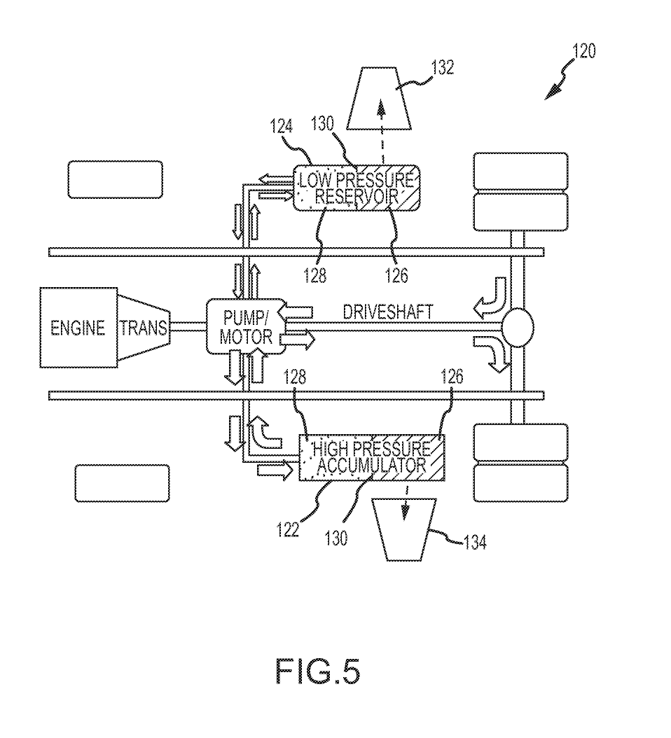

FIG. 5 is a schematic of a hybrid hydraulic system 120 for a hybrid hydraulic vehicle. Hybrid hydraulic vehicles use stored hydraulic energy to reduce fuel consumption. It works similar to regenerative braking used in hybrid electric vehicles (HEV). The difference is that, instead of charging a battery during braking, a hydraulic fluid is pressurized. It is this pressurization process that slows the vehicle down. This pressurized fluid then releases its energy when the vehicle accelerates, allowing most of the braking energy (which would otherwise be lost) to be recouped. This reduces fuel consumption.

In the high-pressure accumulator 122 and low-pressure reservoir 124, the cross-hatching represents a mixture of Nitrogen gas and Kr-85 tracer gas 126, and the dots represents hydraulic fluid 128. Usually a bladder 130 of some sort is used to separate the hydraulic fluid from the gas. The bladder contains the mixture so that it contracts and expands as hydraulic fluid enters and exits the accumulator, respectively.

Hydraulic fluid is much easier to pump than a gas would be, but it cannot be compressed. However, a gas can be compressed and is much better at storing mechanical energy than a fluid. Therefore, a gas-fluid combination is ideal. The Nitrogen/Kr-85 gas mixture acts as a gas “spring” which stores and releases energy as the hydraulic fluid shuttles back and forth, in and out of the high-pressure accumulator. Nitrogen gas is used because it is inert and non-explosive at high pressures.

To deliver the necessary power, the pressure inside the high-pressure accumulator must be very high, as much as 5000-7000 psi. The pressure inside the low-pressure reservoir is much lower, 100-200 psi, and serves to provide the necessary pressure differential as the hydraulic fluid is pumped into and out of the high-pressure accumulator. The accumulator and reservoir are typically constructed out of carbon fiber material which is high-strength and much lighter than steel.

Gamma detectors 132 and 134 may be positioned to detect and count gamma rays emitted by the mixture inside the low-pressure reservoir and high-pressure accumulator, respectively. In this system, the gas should be conserved, therefore any loss of mass is indicative of a leak.

For pressurized bottles that are made out of metal, the beta particles that are emitted by the Kr-85 tracer gas do not penetrate through and out of the bottle. As such, detection of beta particles as positive proof of mass inside the bottle is not possible. However, the presence of beta particles is positive proof that the gas mixture is leaking out of the bottle. Because the gas tends to rapidly disperse once outside the bottle the count of beta particles is not generally accurate enough to make a negative inference regarding how much mass is left inside the bottle. But the presence of any beta particles is proof of a leak. The combination of gamma detection of gamma rays emanating from Kr-85 tracer gas inside the bottle as positive verification of gas inside the bottle and beta detection of beta particles emanating from Kr-85 tracer gas leaking outside the bottle as positive verification of a leak provides a more robust system for monitoring the pressurized bottles.

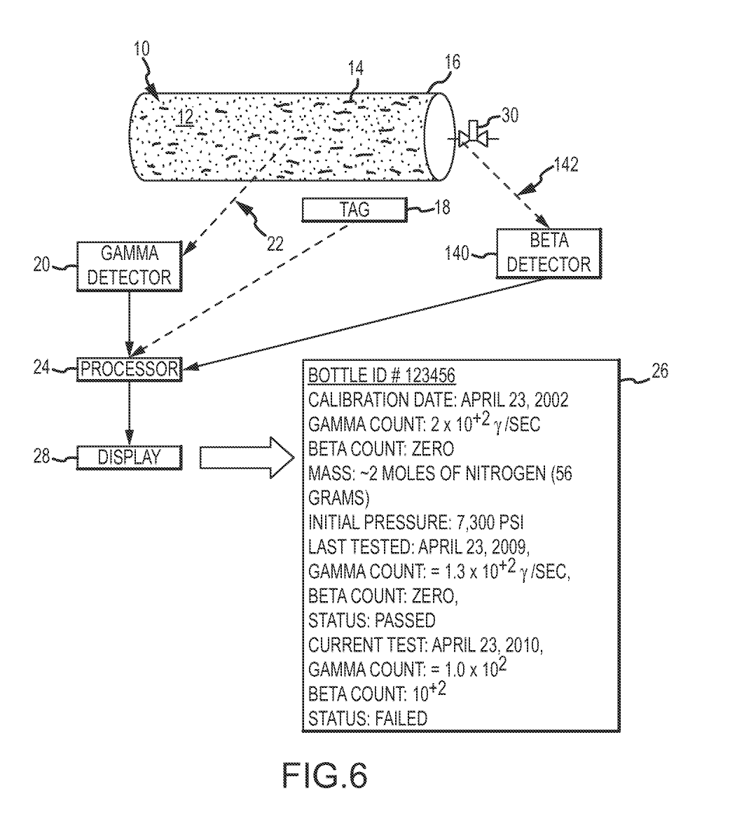

As shown in FIG. 6, the pressurized-bottle 16 and gamma detector 20 of FIG. 1 are augmented with a beta detector 140. The beta detector (one or more) may suitably positioned where the likelihood of defects, hence leaks, is more likely such as valve 30. The beta detector is configured to detect beta particles 142 either continuously or with a suitably high frequency in order to detect leaks as they occur. See for example P. Bilski et al. “Ultra-Thin LiF;Mg, Cu, P Detectors for Beta Dosimetry” Radiation Measurements, Vol. 24, No. 4, pp. 439-443, 1995. Processor 24 monitors the beta count, and if the count exceeds some threshold (e.g. zero or a nominal background level) reports out the existence of a leak. Any leak detection may constitute failure. A detected leak may also trigger a gamma detection to positively verify the mass inside the bottle. This example assumes a 40% detection efficiency with the occurrence of leak at the time of the current test, which is recorded by a lower than expected gamma count and a non-zero beta count.

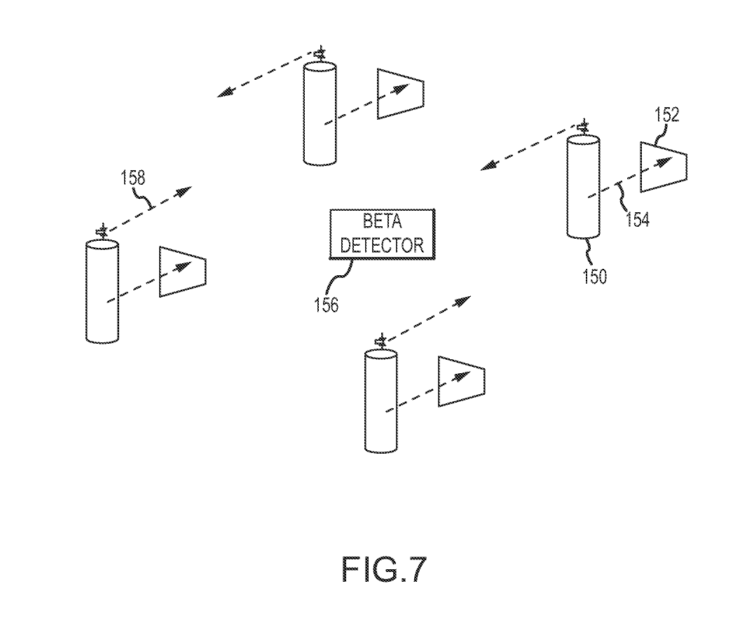

As shown in FIG. 7, a system may comprise multiple pressurized-bottles 150 including mixtures of a carrier gas and a Kr-85 tracer gas. These bottles are emplaced in-situ to perform functions for one or more subsystems. Each bottle is provided with its own gamma detector 152 to detect gamma rays 154 emanating from tracer gas inside the bottle provide positive verification of mass inside that bottle. One or more beta detectors 156 are positioned within the system to detect the presence of Kr-85 beta particles 158. The detection of any beta particles or a level of beta particles above a nominal background level may trigger an alarm that one or more of the bottles may have a leak. In response, each bottle may conduct a gamma test to provide positive verification of the mass in each bottle. Alternately, if the bottle(s) are in an enclosed environment that traps the mixture as it leaks from the bottle, the beta count can be used to normalize the detected gamma data from inside and outside the bottle to determine the mass inside the bottle.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. An apparatus, comprising:
a mixture of a carrier gas and a Kr-85 tracer gas in a pressurized bottle;
a tag providing a calibration date, a calibrated mass and a calibrated Kr-85 gamma count;
a gamma detector external to said bottle to count gamma rays emitted by the Kr-85 tracer gas inside the bottle through said bottle; and
a processor that calculates from the gamma count and the half-life properties of Kr-85 a test mass, said processor comparing the test mass to the calibrated mass to provide positive verification of mass in the pressurized bottle.

2. The apparatus of claim 1, wherein the carrier gas is one of Nitrogen, Argon, Krypton 84 and Helium.

3. The apparatus of claim 1, wherein the KR-85 tracer gas constitutes at most one mole percent of the mixture.

4. The apparatus of claim 1, wherein the mixture is pressurized to at least 3,500 PSI at calibration.

5. The apparatus of claim 1, wherein the gamma detector comprises:
an optical fiber wrapped around the bottle, said fiber being doped with active elements so that incident gamma rays produce an optical pulse in the fiber;
a photo detector coupled to the optical fiber to generate an electrical pulse in response to detected optical pulses; and
a counter that process the electrical pulses to provide the gamma count.

6. The apparatus of claim 1, wherein the pressurized bottle is configured to release all of the gas in one shot.

7. The apparatus of claim 1, further comprising a beta detector external to said bottle to count beta rays emitted by Kr-85 tracer gas as it leaks out of the bottle.

8. The apparatus of claim 1, wherein the pressurized bottle and gamma detector are in-situ in a system, said pressurized bottle configured to provide pressurized carrier gas for cooling, actuation or fire suppression of a sub-system.

9. An apparatus, comprising a mixture of a carrier gas and a Kr-85 tracer gas in a pressurized bottle, said mixture pressurized to at least 3,500 PSI, said Kr-85 tracer gas emitting gamma rays that penetrate through the bottle.

10. The apparatus of claim 9, wherein the KR-85 tracer gas constitutes at most one mole percent of the mixture.

11. The apparatus of claim 9, further comprising an active optical fiber wrapped around the bottle and a photo detector coupled to the optical fiber.

12. An apparatus, comprising:
a mixture of a carrier gas and a Kr-85 tracer gas in a pressurized bottle; and
a tag providing a calibration date, a calibrated mass and a calibrated Kr-85 gamma count.

13. The apparatus of claim 12, wherein the KR-85 tracer gas constitutes at most one mole percent of the mixture.

14. The apparatus of claim 12, wherein the mixture is pressurized to at least 3,500 PSI at calibration.

15. The apparatus of claim 12, wherein the tag comprises a bar code.

16. The apparatus of claim 12, wherein the tag comprises an RF tag.

17. A method of positive verification of presence of mass in a pressurized bottle, comprising:
providing of a mixture of a carrier gas and a Kr-85 tracer gas in a high-pressure bottle;
tagging the bottle with a calibration date, a calibrated mass and a calibrated Kr-85 gamma count;
incorporating the bottle in-situ in a system to provide cooling, actuation or fire suppression of a sub-system;
measuring a test gamma count of gamma rays emitted by the Kr-tracer gas inside the bottle through the walls of the bottle;
calculating from the test gamma count and the half-life properties of Kr-85 a test mass; and
comparing the test mass to the calibrated mass to provide positive verification of mass in the pressurized bottle.

18. The method of claim 17, wherein the KR-85 tracer gas constitutes at most one mole percent of the mixture.

19. The method of claim 17, wherein the mixture is pressurized to at least 3,500 PSI at calibration.

20. The method of claim 17, further comprising detecting beta rays emitted by the Kr-tracer gas as the mixture leaks from the bottle.
